(19) United States
(12) Patent Application Publication
(10) Pub. No.: US 2026/0194356 A1
(43) Pub. Date: Jul. 9, 2026

(54) NAVIGATION SYSTEM FOR ADJUSTING VEHICLE LOCATION BY MATCHING NATURALISTIC SIGNS WITH POINTS OF INTEREST ON A MAP WHEN GPS IS FAULTY

(71) Applicant: GM GLOBAL TECHNOLOGY OPERATIONS LLC, Detroit, MI (US)

(72) Inventors: Brent Navin Roger BACCHUS, Sterling Heights, MI (US); Alireza ESNA ASHARI ESFAHANI, San Bruno, CA (US)

(21) Appl. No.: 19/011,072

(22) Filed: Jan. 6, 2025

(51) Int. Cl. G01C 21/30; G06V 10/74; G06V 20/58

(52) U.S. Cl. CPC G01C 21/30; G06V 10/761; G06V 20/582

(57) ABSTRACT

A navigation system for a vehicle includes a global positioning system (GPS) configured to generate GPS data for the vehicle. A navigation system is configured to store a map including points of interest and locations of the points of interest. A camera is configured to generate images in a path of the vehicle. An image processing module is configured to identify naturalistic signs and locations of the naturalistic signs from the images and to output cropped sign images and locations of the cropped sign images. An alignment module is configured to adjust a location of the vehicle in response to the cropped sign images and the locations of the cropped sign images and the points of interest and the locations of the points of interest from the map.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to navigation systems for vehicles, and more particularly to a navigation system for adjusting vehicle location by matching naturalistic signs with points of interest on a map when an output of a global positioning system (GPS) is faulty.

Global positioning systems (GPS) provide location data for vehicles along a route. In some driving situations such as deep urban environments, the GPS may not be as dependable as desired.

### SUMMARY

A navigation system for a vehicle includes a global positioning system (GPS) configured to generate GPS data for the vehicle. A navigation system is configured to store a map including points of interest (POIs) and locations of the POIs. A camera is configured to generate images in a path of the vehicle. An image processing module is configured to identify naturalistic signs and locations of the naturalistic signs from the images and to output cropped sign images and locations of the cropped sign images. An alignment module is configured to adjust a location of the vehicle in response to the cropped sign images and the locations of the cropped sign images and the POIs and the locations of the POIs from the map.

In other features, the alignment module includes a POI identifier module configured to identify the POIs and the locations of the POIs corresponding to the images. The alignment module implements a vision-language alignment system configured to estimate matches between text related to the POIs and the cropped sign images. The vision-language alignment system includes a multi-modal embedding generation model. The multi-modal embedding generation model is configured to generate similarity values.

In other features, the alignment module includes an association and registration module configured to selectively adjust the location of the vehicle in response to selected ones of the similarity values and corresponding locations of the POIs. The association and registration module includes a threshold module configured to compare the similarity values to a predetermined threshold. The threshold module selects the selected ones of the similarity values that are greater than the predetermined threshold.

In other features, the association and registration module includes a calculating module configured to calculate a von-Mises Fisher likelihood based on the selected ones of the similarity values. The association and registration module includes a modified coherent point drift module configured to generate probabilities that the POIs are associated with the cropped sign images. The association and registration module includes an association matrix and rigid transform module configured to adjust the location of the vehicle based on the probabilities generated by the modified coherent point drift module.

A method for determining a location of a vehicle includes generating a global positioning system (GPS) data for the vehicle; storing a map including points of interest (POIs) and locations of the POIs; generating images in a path of the vehicle; identifying naturalistic signs and locations of the naturalistic signs from the images and outputting cropped sign images and locations of the cropped sign images; and adjusting a location of the vehicle in response to the cropped sign images and the locations of the cropped sign images and the POIs and the locations of the POIs from the map.

In other features, the method includes identifying the POIs and the locations of the POIs corresponding to the images. The method includes using a vision-language alignment system to estimate matches between text related to the POIs and the cropped sign images.

In other features, the vision-language alignment system includes a multi-modal embedding generation model. The multi-modal embedding generation model is configured to generate similarity values. The method includes selectively adjusting the location of the vehicle in response to selected ones of the similarity values and corresponding locations of the POIs.

In other features, the method includes comparing the similarity values to a predetermined threshold; and selecting the selected ones of the similarity values that are greater than the predetermined threshold. The method includes calculating a von-Mises Fisher likelihood based on the selected ones of the similarity values. The method includes using a modified coherent point drift to generate probabilities that the POIs are associated with the cropped sign images; and adjusting the location of the vehicle based on the probabilities.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a navigation system according to the present disclosure;

FIG. 2 is a functional block diagram of an example of an alignment system configured to match locations of naturalistic signs from images generated by cameras with points of interest and their locations from maps according to the present disclosure;

FIG. 3 is a functional block diagram of an example of an alignment system configured to match naturalistic signs with maps according to the present disclosure;

FIG. 4 is a flowchart of an example of a method for matching locations of naturalistic signs from images generated by cameras with points of interest and their locations on maps according to the present disclosure;

FIGS. 5A to 5I are images of examples of signs cropped and isolated from images generated by cameras of the vehicle;

FIG. 6 is an example of a score matrix including similarity values between a business name in the images and possible businesses identified as points of interest according to the present disclosure; and

FIG. 7 illustrate an example of root mean squared estimated translation error as a function of GPS translation error for position information only and for position and similarity values according to the present disclosure.

In the drawings, reference numbers may be reused to identify similar and/or identical elements.

### DETAILED DESCRIPTION

While the present disclosure relates to navigation systems for vehicles that determine vehicle locations by matching naturalistic signs such as business signs, traffic signs, and/or street signs cropped from images generated by cameras with map-based points of interest, the navigation systems can be used for other types of transportation.

Vehicles include navigation systems that receive vehicle location data from a global positioning system (GPS). The navigation system locates the vehicle relative to stored maps and provides route data from a current location of the vehicle to a desired destination. However, the GPS may have a difficult time determining a location of the vehicle accurately in some locations such as deep urban areas due to interruptions, obstructions, and the like.

The present disclosure relates to determining a location of the vehicle by matching naturalistic signs perceived in a driving environment with points of interest (POI) and their corresponding locations provided by stored maps. Examples of the POI data include business signs, traffic signs, and/or street signs and their locations. Matching text from signs in the images with the POIs is not binary since compensation must be made for variations in wording and/or appearance.

In some examples, a vision-language alignment system can be used that includes multi-modal embedding generation models such as contrastive language-image pre-training (CLIP), bootstrapping-language image pre-training (BLIP), ALIGN, locked-image text tuning (LiT), VisualBERT, LXMERT, VILBERT, UNITER, SimVLM, ALBEF, and like. For example, CLIP is a neural network trained on a variety of image and text pairs. CLIP can be instructed in natural language to predict the most relevant text snippet (e.g., a business name from a sign), given an image and candidate text, without directly optimizing for the task.

Images from the vehicle cameras are processed to detect one or more signs in the images. The images are cropped around the one or more signs. The multi-modal embedding generation model is used to generate embeddings for the text and the image and to estimate matches between candidate text (e.g., POI business names or street names generated by the map) and the localized sign images. Locations of each of the one or more localized sign images are determined (e.g., relative to an ego frame and then converted to longitude and latitude values).

The maps identify POIs (e.g., businesses) and their locations in the path of the vehicle. An embedding score matrix (e.g., including similarity values) is generated for all pairs of candidate POI names and sign crops using the multi-modal embedding generation model for all signs in the field of view. In some examples, the results of the similarity values above a predetermined threshold are analyzed further.

Von Mises-Fisher likelihood values are calculated based on the similarity values that are above the threshold. Modified coherent point drift values are generated using a rigid coherent point drift modified by the Von Mises-Fisher likelihood values and the corresponding locations of the POIs. An association matrix and rigid transform selectively adjusts the location of the vehicle if needed. This approach can be used to determine the location of the vehicle along a route in GPS-denied environments without requiring precise HD maps.

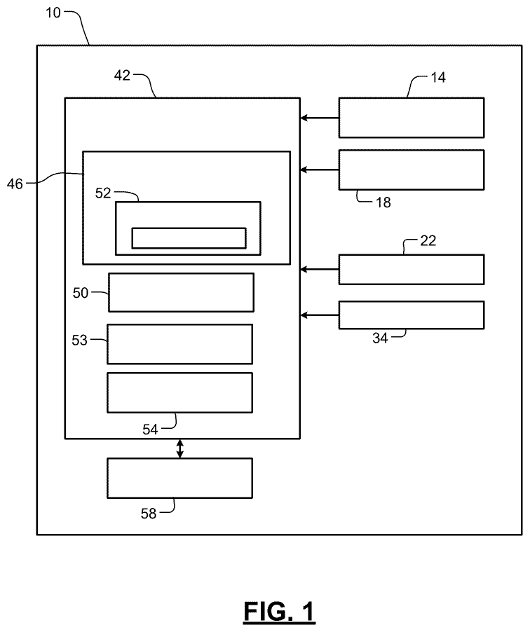

Referring now to FIG. 1, an example of a vehicle 10 includes a global position system (GPS) 14 configured to generate coordinates of the vehicle 10. If the vehicle 10 is an autonomous vehicle, the vehicle 10 may include a radio detection and ranging (radar) system 18 and/or a light detection and ranging (lidar) system that can be used to detect objects in the path of the vehicle. The vehicle 10 includes one or more cameras 34 that generate images located in the path of the vehicle.

The vehicle 10 includes a controller 42 including a navigation module 46, an alignment module 50, an image processing module 53, and an optional autonomous driving module 54. The navigation module 46 is configured to navigate the vehicle relative to a map 52 including points of interest (POIs) and their corresponding locations (e.g., longitude and latitude coordinates). The image processing module 53 is configured to identify and localize (or crop) signs in images generated by the cameras 34 (and their corresponding locations). Lidar, radar, or other range sensors may also be utilized for this purpose. An alignment module 50 is configured to determine the location of the vehicle relative to naturalistic signs in the path of the vehicle and the points of interest and their locations (e.g., longitude and latitude coordinates).

The controller 42 may also include an autonomous driving module 54 configured to automatically operate steering, braking, and acceleration of the vehicle when enabled. The autonomous driving module 54 receives vehicle inputs such as vehicle speed, wheel speed, steering angle, brake pedal position, accelerator position, etc. When enabled, the autonomous driving module 54 is configured to control steering, braking, and/or acceleration along a route from a current location of the vehicle to a destination location based on GPS data and/or selectively alignment using the naturalistic signs.

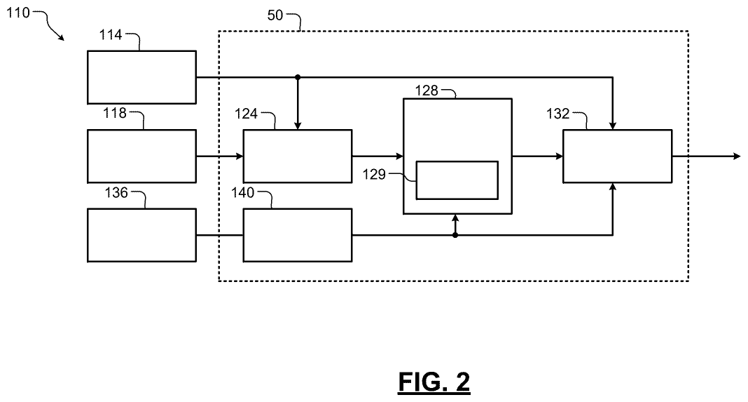

Referring now to FIG. 2, coordinates output by the GPS 114 are input to a point of interest (POI) identifier module 124 and an association and registration module 132. A map module 118 provides POI data and location data for a current vehicle path to the POI identifier module 124 based on a location and heading of the vehicle.

Cameras 136 output images (in a direction that the vehicle is travelling) to an image processing module 140. The image processing module 140 identifies signs in the images, localizes the image (finding sign location in the image, zooming and/or cropping the image around the sign), and forwards the localized sign images to a similarity score matrix calculating module 128.

The similarity score matrix calculating module 128 includes a multi-modal embedding generation model 129 that generates a similarity score matrix. In some examples, the similarity score matrix is based on cosine similarity values, dot product, Euclidean distance, or the like between POI business names, traffic information, or street names and image crops corresponding to the localized sign images. The image processing module 140 outputs locations or coordinates of the localized sign images to the association and registration module 132.

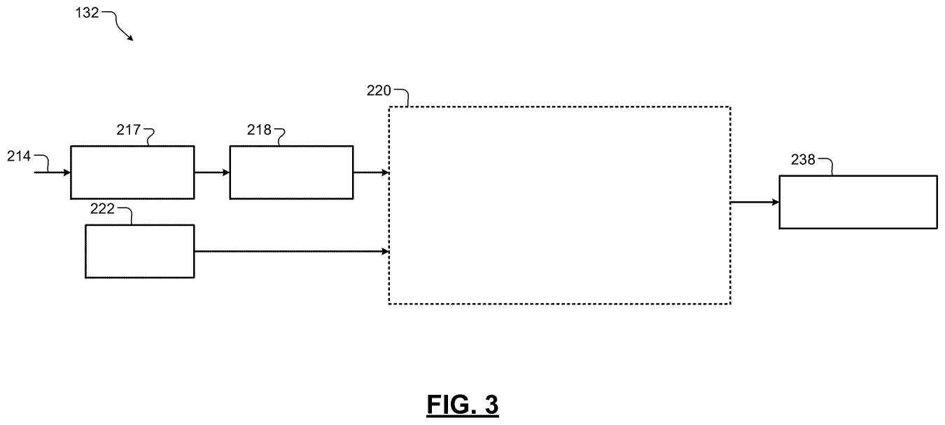

Referring now to FIG. 3, the association and registration module 132 is shown in further detail. The similarity score matrix 214 is input to a threshold module 217 that applies a threshold to the scores in the matrix. In other words, only signs with a sufficiently high score are output to a von Mises-Fisher likelihood calculating module 218. Each embedding score cₘₙ between image m and POI n is converted to a von Mises-Fisher likelihood lₘₙ using the following relationship:

$${l}_{mn} = {C}_{p} ( κ ) exp ( κ \cdot {c}_{mn} )$$

Where Cp(κ) is a normalizing constant and κ is tunable parameter.

The likelihood values output by the von Mises-Fisher likelihood calculating module 218 are input to a modified coherent point drift module 220. The modified coherent point drift module 220 generates probability values based upon a rigid coherent point drift module that is modified by the likelihood values lₘₙ (with s=1) as follows:

$${p}_{mn} = \frac{{l}_{mn} {exp}^{- \frac{1}{2 {σ}^{2}} {‖ {x}_{n} - ( {sRy}_{m} + t ) ‖}^{2}}}{{\sum }_{k = 1}^{M} {l}_{mn} {exp}^{- \frac{1}{2 {σ}^{2}} {‖ {x}_{n} - ( {sRy}_{k} + t ) ‖}^{2}} + {( 2 {πσ}^{2} )}^{D / 2} \frac{w}{1 - w} \frac{M}{N}}$$

Where cₘₙ is an input corresponding to a cosine similarity between a sign n (image) and a POI m (text), yₘ is an input corresponding to a 2D coordinate of a POI m location in a Cartesian frame (e.g., ENU coordinates), xₙ is an input corresponding to a 2D coordinate of a sign n in ego frame, w is an input corresponding to an outlier probability, and σ² is an input corresponding to noise variance in yₘ. D is the number of dimension of the point set (e.g., D=2). M and N correspond to the number of points in the point set.

pₘₙ is an output corresponding to a probability that m is associated with n. R and t are a rotation matrix and translation vector to align m with n. Additional details relating to the rigid coordinate point drift can be found in Myronenko, Andriy, and Xubo Song, “Point set registration: Coherent point drift”, IEEE Transactions on Pattern Analysis and Machine Intelligence 32.12 (2010): 2262-2275, which is hereby incorporated by reference in its entirety. As noted above, the formula in this paper is modified as described herein by the likelihood values lₘₙ.

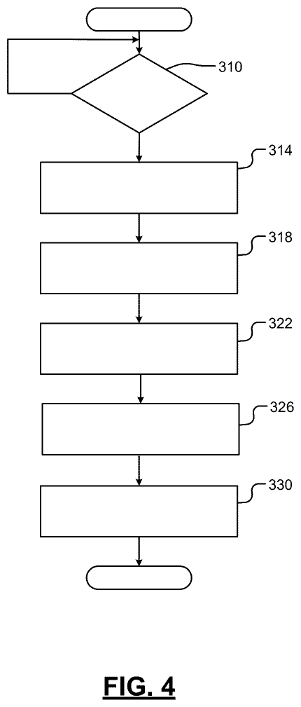

Referring now to FIG. 4, a method for aligning a navigation system using naturalistic signs is shown. At 310, the method determines whether signs are detected in images obtained from the cameras in the path of the vehicle. The method crops and localizes the signs. If 310 is true, the method identifies POIs and their locations from the map at 314 corresponding to the vehicle path. At 318, a similarity score matrix is generated. At 322, position and appearance alignment is determined using locations of the POIs. At 326, final correspondence is determined. At 330, the location of the vehicle is aligned to the route.

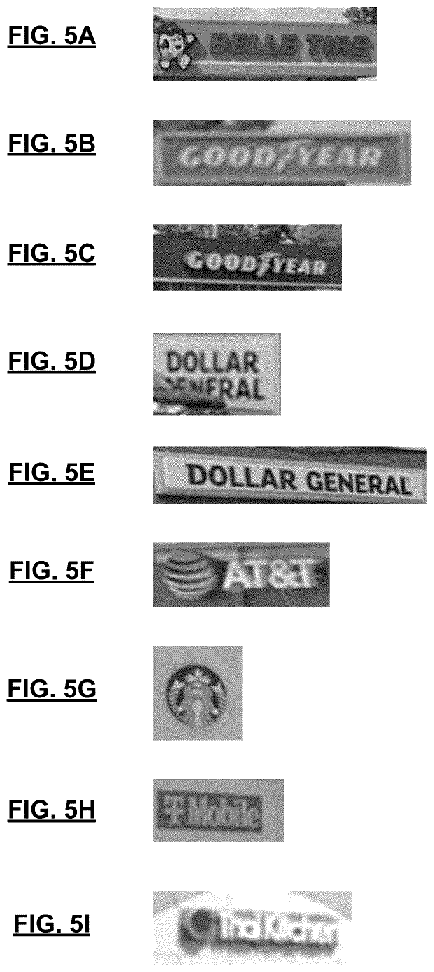

Referring now to FIGS. 5A to 5I, images are shown for examples of signs cropped and localized from a sample image (similar to one taken from a vehicle). In FIG. 5A, a portion of the image is isolated and includes a Belle Tire sign. In FIGS. 5B and 5C, a portion of the image is isolated and includes a Goodyear sign. In FIGS. 5D and 5E, a portion of the image is isolated and includes a Dollar General sign. In FIG. 5F, a portion of the image is isolated and includes an AT&T sign. In FIG. 5G, a portion of the image is isolated and includes a Starbucks sign. In FIG. 5H, a portion of the image is isolated and includes a T-Mobile sign. In FIG. 5I, a portion of the image is isolated and includes a Thai Kitchen sign. The cropped images (e.g., those shown in FIGS. 5A to 5I) are supplied along with first location data (longitude and latitude).

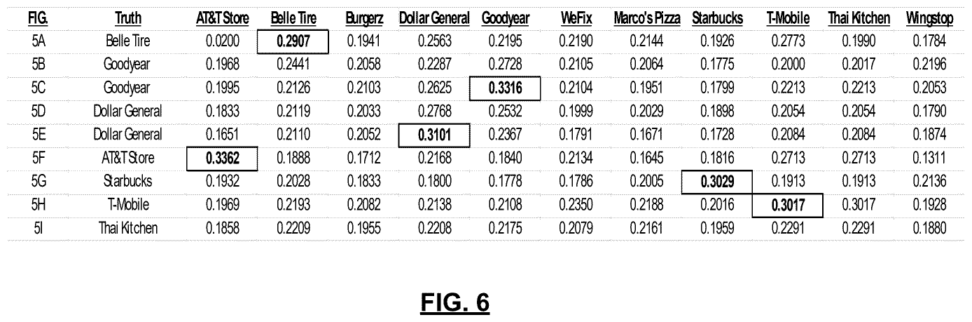

Referring now to FIG. 6, an example of a similarity score matrix includes cosine similarity values between the localized sign images and the POI business names (e.g., generated using the CLIP model as the vision-language alignment system). The cosine similarity may be computed as the normalized dot product between the text and image embedding vectors.

As can be appreciated, it would be desirable for the highest cosine similarity values in each column of the similarity score matrix to correspond to the ground truth business name. While this is mostly true, reliance upon this information may lead to mistakes. For example, Thai Kitchen is not identified accurately. To reduce errors, the association and registration module 132 uses the location data for the POIs to increase the accuracy of the data.

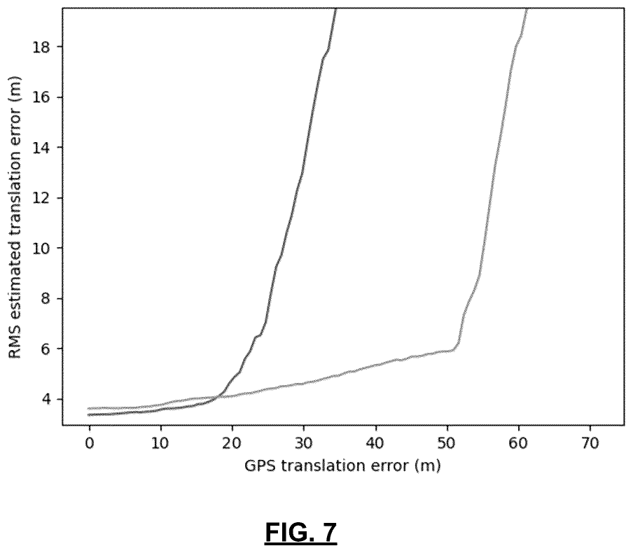

Referring now to FIG. 7, root mean squared estimated translation error is shown as a function of GPS translation error for position information only and for position and cosine similarity values. Using the data shown above, GPS error was varied randomly and a registration error was measured for position information only (no vision-language alignment system) and for position information using the vision-language alignment system. For GPS error <18 m, association is possible with either approach. For GPS error <50 m, association using position and the vision-language alignment data is significantly more robust with 3 to 4 m alignment accuracy within above ranges. Zero alignment error is not possible due to bias in sign-POI location. The dataset was not necessarily typical due to the large number of perceived signs. With fewer signs, association using position and the vision-language alignment data performs significantly better. In this example, the vision-language alignment system is CLIP.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A navigation system for a vehicle, comprising:
a global positioning system (GPS) configured to generate GPS data for the vehicle;
a navigation system configured to store a map including points of interest (POIs) and locations of the POIs;
a camera configured to generate images in a path of the vehicle;
an image processing module configured to identify naturalistic signs and locations of the naturalistic signs from the images and to output cropped sign images and locations of the cropped sign images; and
an alignment module configured to adjust a location of the vehicle in response to:
the cropped sign images and the locations of the cropped sign images; and
the POIs and the locations of the POIs from the map.

2. The navigation system of claim 1, wherein the alignment module includes a POI identifier module configured to identify the POIs and the locations of the POIs corresponding to the images.

3. The navigation system of claim 1, wherein the alignment module implements a vision-language alignment system configured to estimate matches between text related to the POIs and the cropped sign images.

4. The navigation system of claim 3, wherein the vision-language alignment system includes a multi-modal embedding generation model.

5. The navigation system of claim 4, wherein the multi-modal embedding generation model is configured to generate similarity values.

6. The navigation system of claim 5, wherein the alignment module includes an association and registration module configured to selectively adjust the location of the vehicle in response to selected ones of the similarity values and corresponding locations of the POIs.

7. The navigation system of claim 6, wherein the association and registration module includes a threshold module configured to compare the similarity values to a predetermined threshold.

8. The navigation system of claim 7, wherein the threshold module selects the selected ones of the similarity values that are greater than the predetermined threshold.

9. The navigation system of claim 8, wherein the association and registration module includes a calculating module configured to calculate a von-Mises Fisher likelihood based on the selected ones of the similarity values.

10. The navigation system of claim 9, wherein the association and registration module includes a modified coherent point drift module configured to generate probabilities that the POIs are associated with the cropped sign images.

11. The navigation system of claim 10, wherein the association and registration module includes an association matrix and rigid transform module configured to adjust the location of the vehicle based on the probabilities generated by the modified coherent point drift module.

12. A method for determining a location of a vehicle, comprising:
generating a global positioning system (GPS) data for the vehicle;
storing a map including points of interest (POIs) and locations of the POIs;
generating images in a path of the vehicle;
identifying naturalistic signs and locations of the naturalistic signs from the images and outputting cropped sign images and locations of the cropped sign images; and
adjusting a location of the vehicle in response to:
the cropped sign images and the locations of the cropped sign images; and
the POIs and the locations of the POIs from the map.

13. The method of claim 12, further comprising identifying the POIs and the locations of the POIs corresponding to the images.

14. The method of claim 12, further comprising using a vision-language alignment system to estimate matches between text related to the POIs and the cropped sign images.

15. The method of claim 14, wherein the vision-language alignment system includes a multi-modal embedding generation model.

16. The method of claim 15, wherein the multi-modal embedding generation model is configured to generate similarity values.

17. The method of claim 16, further comprising selectively adjusting the location of the vehicle in response to selected ones of the similarity values and corresponding locations of the POIs.

18. The method of claim 17, further comprising:
comparing the similarity values to a predetermined threshold; and
selecting the selected ones of the similarity values that are greater than the predetermined threshold.

19. The method of claim 18, further comprising calculating a von-Mises Fisher likelihood based on the selected ones of the similarity values.

20. The method of claim 19, further comprising:
using a modified coherent point drift to generate probabilities that the POIs are associated with the cropped sign images; and
adjusting the location of the vehicle based on the probabilities.
